(19) United States
(12) Patent Application Publication
(10) Pub. No.: US 2018/0213813 A1
(43) Pub. Date: Aug. 2, 2018

(54) SYSTEM FOR PRODUCING FOODS

(71) Applicant: BÜHLER GMBH, Bergneustadt (DE)

(72) Inventors: Sebastian LENSSEN, Köln (DE); Benjamin FUHR, Reichshof (DE); Daniel BALDUS, Reichshof (DE); Christian WALTER, Wil (CH); Katharina HILKER, Rahden (DE)

(21) Appl. No.: 15/738,258

(22) PCT Filed: Jun. 21, 2016
(86) PCT No.: PCT/EP2016/064249

§ 371 Date: Dec. 20, 2017

(30) Foreign Application Priority Data
Jul. 1, 2015 (EP) 15174821.7

(51) Int. Cl. A23G 1/00; A23G 1/26; A23G 3/34; A23G 3/02; A23G 7/00

(52) U.S. Cl. CPC A23G 1/0093; A23G 1/26; A23G 3/0036; A23G 7/0087; A23G 7/0025; A23G 7/0037; A23G 7/0075; A23G 3/0278

(57) ABSTRACT

A system (1) for producing foods, in particular a chocolate system, comprising at least one treatment station and at least one industrial robot (2, 3), which comprises at least one effector (4) having at least one receiving device for at least one product carrier (14) and comprises at least one manipulator (13) for transferring the at least one product carrier (14). The industrial robot (2, 3) additionally comprises at least one control device, preferably at least one associated processing device, and the control device is or can be set in such a way that the product carrier (14), preferably at and/or opposite a treatment station and/or between two treatment stations, can be shaken, spun, turned, rotated, slid, raised, lowered, blown at, suctioned out, cleaned, stacked and/or unstacked, cleared out by knocking, emptied, filled, temperature-controlled, and/or, in particular under sensor control, moved along a predetermined path.

The invention relates to a system for producing foodstuffs, in particular a chocolate system, having at least one treatment station and having at least one industrial robot; to a method for transporting at least one product carrier, in particular a mold, between two treatment stations; to the use of an industrial robot; and to a method for converting a system for producing foodstuffs.

Molds, preferably from plastics (for example a blister pack, or a see-through pack), metal, or else wood, in various sizes and having product-specific cavities shaped therein are used for the production of confectionery, especially chocolate products. The molds are typically moved between the processing stations by means of a chain or of an endless belt, as is described in, for example, U.S. Pat. No. 5,180,602 or DE 3740109.

The chain pushes or pulls the molds. The molds could also bear loosely on a conveyor belt and be entrained by frictional engagement. The molds herein are moved in cycles or in a continuous operation, typically in one direction between individual processing stations.

Chain and belt conveyors are typically attached so as to be locationally fixed between treatment stations that are likewise installed in a locationally fixed manner. This is favorable in the case of large systems in which the production sequence is fixedly predefined and which rarely have to be converted.

Systems for producing foodstuffs are often overall systems having various treatment stations or sections. The known systems are often tailored to special application purposes, for example for filled pralines or bars, in order to enable high throughput rates at high precision. The conversion from one product to another product is typically complex, in some instances even impossible.

This can be problematic when comparatively small batches are to be made or when a new product is to be introduced. The conversion in this instance is so complex that a high economic risk is associated therewith.

A system for the production of foodstuffs in which sections of the production line can be bridged by transfer installations such as robots or pneumatic pick-and-place devices, in that the foodstuffs that are disposed in the product carriers are transferred between sections that are mechanically independent of one another, is known from EP0940086.

More flexibility can be achieved by a transport truck system in which transport trucks having a dedicated drive move along track elements which in a modular manner can be combined to form a transportation track. In the case of this system, too, the track has to be rebuilt for a modified production sequence.

Small flexible systems that are easy to handle and meet high standards of hygiene are required for producers of foodstuff products, in particular chocolate products, of high quality, that produce small quantities of seasonal products and small quantities for marketing tests, or that would like to take the route toward industrial production.

It is, therefore, the object to provide a system for producing foodstuffs, in particular a chocolate system, and a corresponding method, which system and method overcome the disadvantages of the prior art and permit high flexibility and a user-friendly, automated production.

The object is achieved by the features of the independent claims. Advantageous refinements are set forth in the following description, in the figures, and in the dependent patent claims.

The object is achieved firstly by a system for producing foodstuffs, in particular a chocolate system, having at least one treatment station and having at least one industrial robot. The industrial robot comprises at least one effector having at least one receptacle for at least one product carrier and at least one manipulator for transferring the at least one product carrier.

The industrial robot additionally comprises at least one control installation and preferably at least one associated processing installation.

The control installation is set or is able to be set in such a manner that the product carrier, preferably at a and/or in relation to a treatment station and/or between two treatment stations, is able to be shaken, and/or spun, and/or turned, and/or rotated, and/or displaced, and/or lifted, and/or lowered, and/or blown down, and/or suctioned, and/or cleaned, and/or stacked and/or unstacked, and/or cleared out by impact, and/or emptied, and/or filled, and/or temperature-controlled, and/or moved, in particular with sensor control, along a predeterminable path by the industrial robot.

The industrial robot is preferably multi-functional and comprises in particular a plurality of processing installations, wherein the control installation is set or is able to be set in such a manner that a plurality of the processing steps that are listed above are able to be carried out in series or in parallel.

In particular, the industrial robot can carry out processing steps which are otherwise assumed by the treatment stations.

The industrial robot can be equipped and be controllable such that the product carrier is able to be shaken. The foodstuff that is located in the product carrier, for example still-liquid chocolate that has been metered in, in this instance is for example distributed uniformly in molds of the product carrier, gas that has been filled escapes from the metered mass, and/or finished or partially finished products are released from the product carrier. The industrial robot can possess a shaking device, or can generate the shaking motion by means of movements of the manipulator and of the effector.

The industrial robot can be equipped and be controllable such that the product carrier is able to be spun. The foodstuff that is located in the product carrier, for example still-liquid chocolate that has been metered in, in this instance is for example distributed uniformly on the walls of molds and forms a hollow body or a shell. The industrial robot can possess a spinning device, or can generate the spinning motion by means of movements of the manipulator and of the effector.

The industrial robot can be equipped and be controllable such that the product carrier is able to be turned. Excess foodstuff in this instance can run out of the molds, for example, and/or finished or partially finished products can drop out of the product carrier. The industrial robot can possess a turning device, or the turning motion is able to be generated by means of movements of the manipulator and of the effector.

The industrial robot can be equipped and be controllable such that the product carrier is able to be rotated. The completion direction in terms of molds on the product carrier can thus be changed, for example. The product carrier, for example when not in use, can also be transported by the industrial robot in an upside-down manner. The industrial robot can possess a rotating device, or the rotating motion is able to be generated by means of movements of the manipulator and of the effector.

The industrial robot can be equipped and be controllable such that the product carrier is able to be displaced. The product carrier thus can be moved conjointly with or in relation to components of the treatment station, for example, in order for the mold to be moved along with the casting nozzle when casting chocolate mass, for example, or to be moved away from the casting nozzle. The industrial robot can possess a displacing device, or the displacing motion is able to be generated by means of movements of the manipulator and of the effector.

The industrial robot can be equipped and be controllable such that the product carrier is able to be lifted and/or lowered. The product carrier can thus be moved, for example, in the vertical direction toward the treatment station, for example toward a lance for piercing, or a die for shaping, and be moved away again. The industrial robot can possess a lifting and/or lowering device, or the lifting motion and/or lowering motion are/is able to be generated by means of movements of the manipulator and of the effector.

The industrial robot can be equipped and be controllable such that the product carrier is able to be blown down and/or suctioned. A cooled product carrier can be blown down with dry air, for example, in order for condensation to be avoided, or dust or remnants of product can be suctioned from the product carrier. Hot or cold air can also be supplied in order for the product carrier and/or the product to be temperature-controlled in a corresponding manner. To this end, the industrial robot can possess a device for generating a gas flow and/or a vacuum, or can possess a connector to such a device.

The industrial robot can be equipped and be controllable such that the product carrier is able to be cleaned. Filled product carriers can thus be imparted a defined surface, or remnants of product can be removed. To this end, the industrial robot can possess a roller and/or a scraper.

The industrial robot can be equipped and be controllable such that the product carrier is able to be stacked and/or unstacked. The product carriers can be acquired by the robot and can also be dispensed again; the industrial robot, at least temporarily, can preferably hold, acquire, and/or dispense an entire stack of product carriers. To this end, the industrial robot can possess a stacking and/or unstacking device.

The industrial robot can be equipped and be controllable such that the product carrier is able to be cleared out by impact. Products and/or remnants of product can be removed from the product carrier in this way. To this end, the industrial robot can possess an impact-clearing device.

The industrial robot can be equipped and be controllable such that the product carrier is able to be emptied and/or filled. The product carrier can be charged with a product or a cleaning agent, and/or said product or cleaning agent can again be discharged from it. A partially filled product carrier can be further filled. To this end, the industrial robot can possess a suction device, a filling station, a feeder, a supply line, or/an output line.

The industrial robot can be equipped and be controllable such that the product carrier is able to be temperature-controlled. The product carrier and/or the product can thus be brought to a desired temperature, be heated or be cooled, and/or be maintained at a desired temperature. To this end, the industrial robot can possess a temperature-control device by way of which an equalization of temperature is caused by way of convection and/or conduction, for example.

The industrial robot can be equipped and be controllable such that the product carrier is able to be moved, in particular with sensor control, along a predeterminable path. In order for a partially finished product to be decorated, for example, the repositioning path of the product carrier, for example on a casting machine, should be freely programmable in order for the decoration means to reach the product in the desired manner. The industrial robot can possess a decorating device, or the movement along a predeterminable path is able to be generated by means of movements of the manipulator and of the effector.

In particular, the industrial robot comprises at least one sensor by way of which it is detectable whether a product carrier is present and/or whether a product is present in the product carrier.

The treatment station is preferably a mold heater, a cooling station, a casting station, a shell-forming station, an opening-forming station, a filling station, a capping station, a decorating station, a de-molding station, a stacking and/or unstacking station, a spraying station, a printer station, an insertion station, a packaging station, and/or a placing station, in particular a film-placing station.

The processing installation is preferably a shaking installation, a spinning installation, a turning installation, a displacing installation, a lifting and/or lowering installation, a rotating installation, a scraping installation, a rolling installation, a blowing installation, and/or a suction installation.

The processing steps that have already been mentioned at the outset can be carried out therewith.

The treatment stations are preferably at least in part mechanically independent of one another, wherein the treatment stations in particular are able to be put into operation in a mutually independent manner.

The flexibility of the system is increased herein since the treatment stations can be retroactively supplemented and/or replaced. It is thus conceivable, for example, that initially a system having only a few treatment stations is put into operation, and further treatment stations are later added to the system.

The industrial robot is preferably repositionable. Alternatively, the industrial robot can be fixedly anchored, in particular directly or by way of a frame, at a spatial position, for example on the floor, on the wall, and/or on the ceiling.

The system preferably has at least one cooling station that in particular is centrally disposed and in particular is operable from more than one side.

In particular in the production of filled chocolate products, semi-finished products have first to be cooled before said semi-finished products can be further processed. An appropriate cooling station which is used several times during a production procedure is thus preferably disposed in a central manner, that is to say between the treatment stations, such that the paths travelled by the industrial robot are small. Furthermore, on account of the operability of the cooling station from more than one side, a cooling station in which, for example, one side serves as the dispensing side and the other side serves as the removal side for an industrial robot can be provided.

The industrial robot is preferably equipped with an installation for identification, in particular with an indicator reader for reading an indicator that is attached to a product carrier and/or to a treatment station.

Different product carriers can thus be simultaneously used for different products, for example, wherein the control installation, or a further unit that is configured in a corresponding manner, identifies the product carrier and carries out a corresponding treatment/processing. Furthermore, on account of the identification of the treatment station, it is likewise possible for treatment stations to be replaced and to be disposed in a manner corresponding to the product or the process, respectively, wherein the system, for example on account of the identification, can itself be capable of learning where each processing unit is positioned.

Preferably, the control installation is computer-programmable, and in particular is equipped with a computer program which permits an optimized transfer and processing sequence.

Herein, different programs for different products can be included in the control installation, for example, said programs permitting the processing of different products, or permitting different processes to be carried out, respectively. On account of the optimization of the transfer and processing sequences, it is furthermore possible for the capacity and the processing rate of the system to be increased to a maximum.

The invention furthermore relates to a method for transporting at least one product carrier, in particular a mold, between two treatment stations in a system for producing foodstuffs, especially chocolate products.

The system in particular can be a system as has been described at the outset. The advantages that have been mentioned there in the context of the system thus also apply to the method according to the invention.

Herein, at least one product carrier, in particular a mold, is conveyed by an industrial robot.

The product carrier herein, preferably at and/or in relation to a treatment station and/or between two treatment stations, is shaken, and/or spun, and/or turned, and/or rotated, and/or displaced, and/or lifted, and/or lowered, and/or blown down, and/or suctioned, and/or cleaned, and/or stacked, and/or unstacked, and/or cleared out by impact and/or emptied, and/or filled, and/or temperature-controlled, and/or moved, in particular with sensor control, along a predeterminable path by the industrial robot.

The product carrier is, by the industrial robot, preferably removed from a treatment station, and/or transferred to a treatment station, and/or transported between treatment stations, and/or transferred to a further industrial robot, and/or acquired by a further industrial robot, and/or transferred to a further system, and/or acquired by a further system.

The product carrier by means of the industrial robot runs through the steps of a production process having processing steps at and/or between treatment stations, or is evacuated from the production process, or is introduced into the production process.

Preferably, in a treatment station, the product carrier is heated, a foodstuff mass is cast, at least one shell is formed, at least one opening is formed in at least one shell, at least one shell is filled, at least one cap is formed, at least one semi-finished product is decorated and/or printed, at least one mold is de-molded, at least one mold is sprayed, and/or at least one product is packaged.

The industrial robot, in particular by means of a sensor, preferably detects the position of the at least one treatment station. In particular, the industrial robot by means of a process unit determines an optimized method sequence.

A flexible arrangement of the processing stations it is thus possible, since the industrial robot per se can determine the position and said position does not have to be pre-programmed in the control installation.

The invention furthermore relates to the use of one of the industrial robots which comprises at least one effector having at least one receptacle for at least one product carrier and at least one manipulator for transferring the at least one product carrier, in a system for producing foodstuffs, in particular a chocolate system, having at least one treatment station.

The industrial robot additionally comprises at least one control installation and preferably at least one associated processing installation.

The control installation is able to be set in such a manner that the product carrier, preferably at a and/or in relation to a treatment station and/or between two treatment stations, is able, by the industrial robot, to be shaken, and/or spun, and/or turned, and/or rotated, and/or displaced, and/or lifted, and/or lowered, and/or blown down, and/or suctioned, and/or cleaned, and/or stacked and/or unstacked, and/or cleared out by impact, and/or emptied, and/or filled, and/or temperature-controlled, and/or moved, in particular with sensor control, along a predeterminable path.

The use of an industrial robot thus has the same advantages as the system according to the invention that has been mentioned at the outset.

The invention furthermore relates to a method for converting a system for producing foodstuffs, in particular a chocolate system, having at least one treatment station.

The method according to the invention herein comprises the following steps:

The dismantling of the existing transportation device for conveying product carriers, in particular between treatment stations, is performed in a first step.

The installation of at least one industrial robot which comprises at least one effector having at least one receptacle for at least one product carrier and at least one manipulator for transferring the at least one product carrier is performed in a second step, wherein the industrial robot additionally comprises at least one control installation and preferably at least one associated processing installation.

The control installation herein is able to be set in such a manner that the product carrier, preferably at or in relation to a treatment station, is able to be shaken, spun, turned, rotated, displaced, lifted, lowered, blown down, suctioned, cleaned, stacked and/or unstacked, cleared out by impact, emptied, filled, temperature-controlled, and/or moved, in particular with sensor control, along a predeterminable path.

It is thus possible for an already existing system to be equipped with an industrial robot. The system thus converted has the same advantages as the system according to the invention, and is particularly suitable for carrying out the method according to the invention.

The invention will be described hereafter by means of a preferred exemplary embodiment in conjunction with the drawing in which:

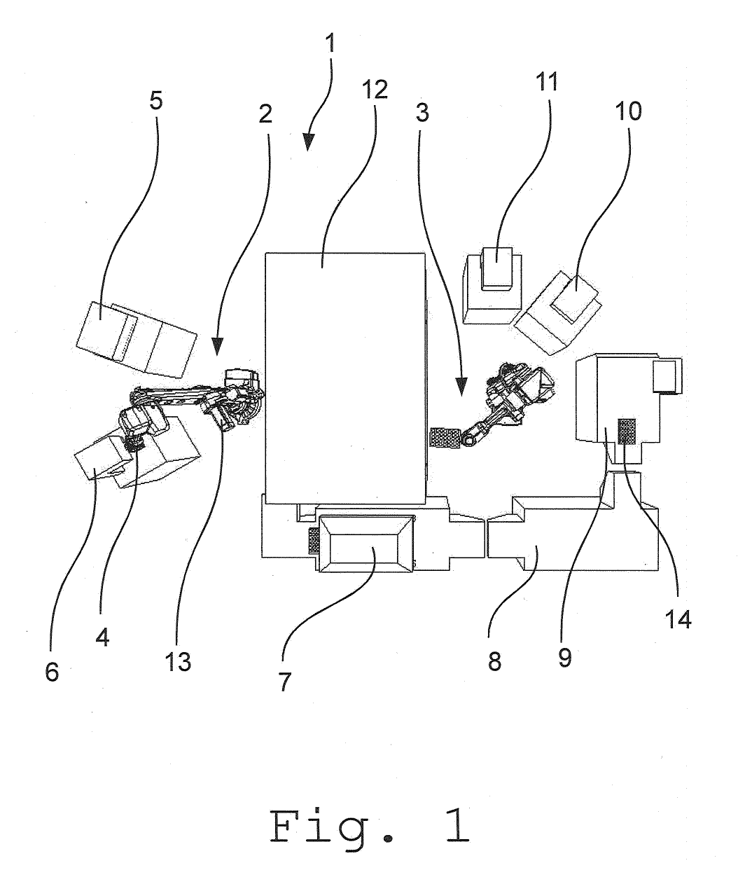

FIG. 1 shows a plan view of a preferred arrangement of a system according to the invention;

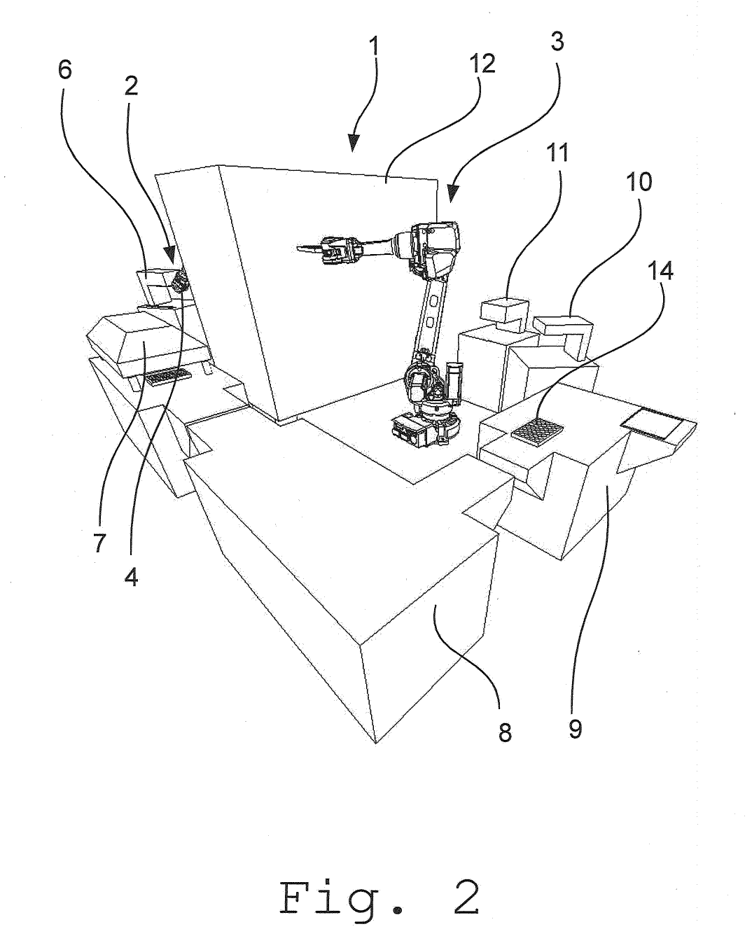

FIG. 2 shows a perspective view of the system of FIG. 1;

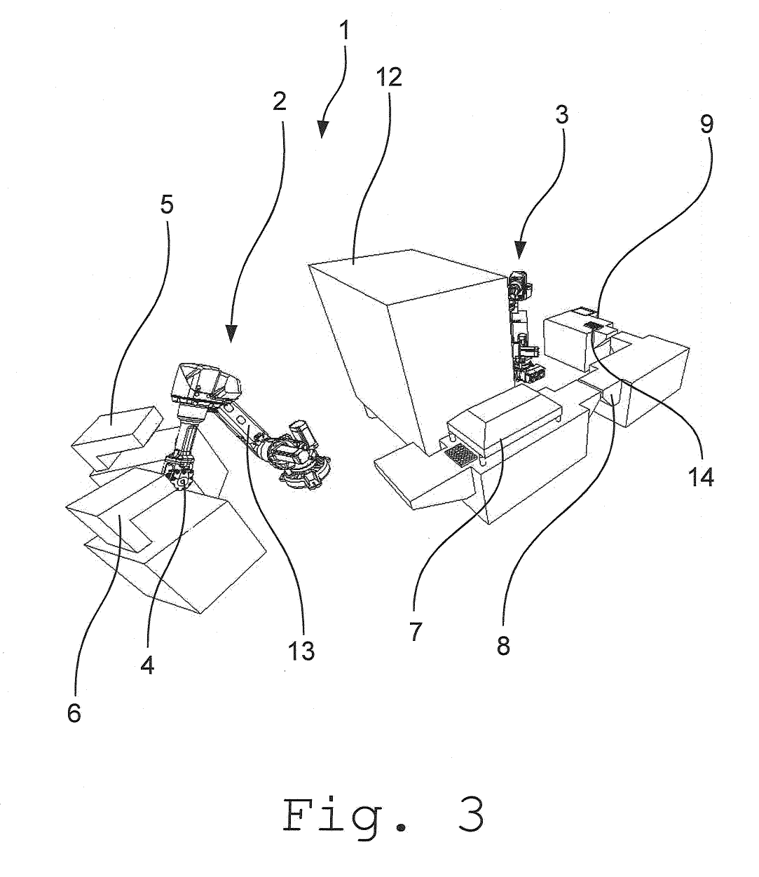

FIG. 3 shows a further perspective view of the system of FIG. 1;

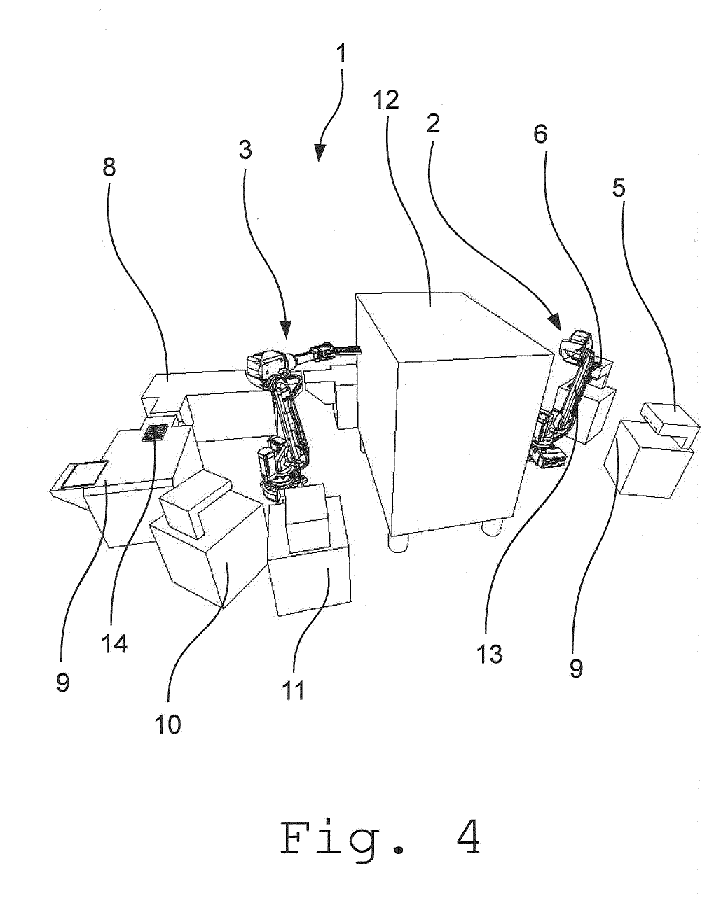

FIG. 4 shows a third perspective view of the system of FIG. 1; and

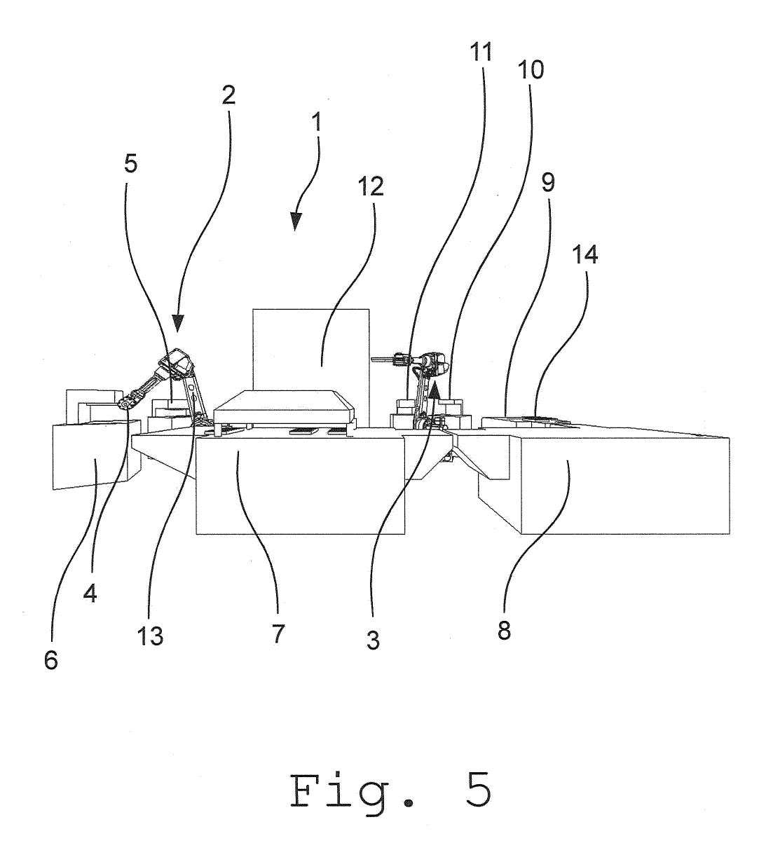

FIG. 5 shows a perspective side view of the system of FIG. 1.

A system 1 for producing chocolate pralines is shown in FIGS. 1 to 5, said system 1 comprising two industrial robots 2 and 3. The industrial robots 2 and 3 are configured as robotic arms 13 having a gripping portion 4 and are disposed in a locationally fixed manner. A product carrier 14 in the form of a casting mold 14 is able to be gripped by way of the gripping portion 4 (wherein for the sake of clarity only one product carrier is provided with a reference sign). The industrial robot 2 or 3, respectively, furthermore permits the handling of the product carrier 14 such that the product carrier 14 is able to be moved or rotated, respectively, in different directions or about different axes, respectively.

A plurality of treatment stations 5-12 are disposed within reach of the industrial robot 2 or 3, respectively. The treatment stations are a shell-forming station 5, a casting station 6, a mold heater 7, a stacking and unstacking station 8, a de-molding station 9, a decorating station 10, a filling station 11, and a cooling station 12.

The cooling station 12 is disposed in a central manner and can be served in each case by one industrial robot 2 or 3, respectively, from a respective side. For example, the product carriers 14 after a processing step can be pushed into the cooling station 12 by the industrial robot 2, and can be removed on the opposite side by the industrial robot 3, optionally once the product carrier 14 and/or the (semi-finished) products contained therein have reached a predetermined temperature or once a predetermined temperature-control time has been reached.

The cooling station 12 can have a plurality of cooling zones such that the corresponding cooling/temperature-control can take place after a processing step without an additional cooling station being required.

On account of the “free” arrangement of the treatment stations 5-12, the latter can be disposed according to the requirements. Also, the treatment stations can be arranged in a different manner, or additional treatment stations can be added, or treatment stations that are not required can be removed, depending on the product.

In the case of this exemplary embodiment, a product carrier 14 is moved by the industrial robot 3 from the stacking and unstacking station 8 to the mold heater 7. The product carrier 14, after heating, is then conveyed by the industrial robot 2 to the casting station 6 where chocolate is cast in order for shells to be formed. The product carrier 14 is subsequently conveyed by the industrial robot 2 to the shell-forming station 5, where the shell is formed by moving the product carrier 14 in relation to a die (not shown), and subsequently to the cooling station 12. When the product carrier 14 is conveyed from the casting station 6 to the shell-forming station 5, the industrial robot 2 can likewise move the product carrier 14 and at least partially carry out the forming of the shells.

Once the shells have been cooled, the product carrier 14 is removed from the cooling station by the industrial robot 3 and is transported to the filling station 11 where the shells are filled, and said product carrier 14 is subsequently moved back to the cooling station 12.

Moreover, a cap can be attached at a capping station or at the filling station 11. The filling station 11 can also be a “one-shot” station where a shell and a filling are simultaneously dispensed.

Once the finished pralines have been cooled, the product carrier 14 can be conveyed by the industrial robot 3 to the decorating station 10 where the pralines are decorated.

The pralines are removed from the product carrier 14 by means of the de-molding station 9 and further processed, for example packaged. Packaging can also be performed by means of a treatment station that is configured to this end and that is served by the industrial robot 2 or 3. At the de-molding station 9, the industrial robot 3 can rotate the product carrier 14 and optionally move the latter in such a manner that the finished pralines are removed from the product carrier 14.

The empty product carrier 14, optionally after cleaning, is subsequently conveyed by the industrial robot 3 to the stacking and unstacking station 8.

1-14. (canceled)

15. A system for producing foodstuffs, having at least one treatment station and having at least one industrial robot comprising at least one effector having at least one receptacle for at least one product carrier and at least one manipulator for transferring the at least one product carrier,
wherein the industrial robot additionally comprises at least one control installation, and the control installation is set or is able to be set in such a manner that the product carrier is able to be:
shaken, and/or
spun, and/or
turned, and/or
rotated, and/or
displaced, and/or
lifted, and/or
lowered, and/or
blown down, and/or
suctioned, and/or
cleaned, and/or
stacked and/or unstacked, and/or
cleared out by impact, and/or
emptied, and/or
filled, and/or
temperature-controlled, and/or
moved along a predeterminable path.

16. The system according to claim 15, wherein the industrial robot additionally comprises at least one processing installation being associated to the at least one control installation.

17. The system according to claim 15, wherein the at least one control installation is set or is able to be set in such a manner that the product carrier at and/or in relation to a treatment station and/or between two treatment stations, is able to be
shaken, and/or
spun, and/or
turned, and/or
rotated, and/or
displaced, and/or
lifted, and/or
lowered, and/or
blown down, and/or
suctioned, and/or
cleaned, and/or
stacked and/or unstacked, and/or
cleared out by impact, and/or
emptied, and/or
filled, and/or
temperature-controlled, and/or
moved along a predeterminable path.

18. The system according to claim 15, wherein the product carrier is able to be moved with sensor control along a predeterminable path.

19. The system according to claim 15, wherein the treatment station is a mold heater, a cooling station, a casting station, a shell-forming station, an opening-forming station, a filling station, a capping station, a decorating station, a de-molding station, a stacking and/or unstacking station, a spraying station, a printer station, an insertion station, a packaging station, and/or a placing station.

20. The system according to claim 16, wherein the processing installation is a shaking installation, a spinning installation, a turning installation, a displacing installation, a lifting and/or lowering installation, a rotating installation, a scraping installation, a rolling installation, a blowing installation, and/or a suction installation.

21. The system according to claim 15, wherein the treatment stations are at least in part mechanically independent of one another.

22. The system according to claim 21, wherein the treatment stations are able to be put into operation in a mutually independent manner.

23. The system according to claim 15, wherein the industrial robot is repositionable, or is fixedly anchored, at a spatial position.

24. The system according to claim 15, wherein the system has at least one cooling station.

25. The system according claim 15, wherein the system has at least one cooling station that is centrally disposed and is operable from more than one side.

26. The system according to claim 15, wherein the industrial robot is equipped with an installation for identification, namely with an indicator reader for reading an indicator that is attached to a product carrier and/or to a treatment station.

27. The system according to claim 15, wherein the control installation is computer-programmable.

28. The system according to claim 27, wherein the control installation is equipped with a computer program which permits an optimized transfer and processing sequence.

29. A method for transporting at least one product carrier between two treatment stations in a system for producing foodstuffs, wherein at least one product carrier is conveyed by an industrial robot,
wherein the product carrier is subjected by the industrial robot to at least one of the following method steps:
being shaken,
being spun,
being turned,
being rotated,
being displaced,
being lifted,
being lowered,
being blown down,
being suctioned,
being cleaned,
being stacked and/or unstacked,
being cleared out by impact,
being emptied,
being filled,
being temperature-controlled, and/or
being moved along a predeterminable path.

30. The method according to claim 29, further comprising subjection the product carrier, via the industrial robot, to at least one of the method steps at and/or in relation to a treatment station and/or between two treatment stations.

31. The method according to claim 29, wherein the product carrier is, by the industrial robot:
removed from a treatment station, and/or
transferred to a treatment station, and/or
transported between treatment stations, and/or
transferred to a further industrial robot, and/or
acquired by a further industrial robot, and/or
transferred to a further system, and/or
acquired by a further system.

32. The method according to claim 29, wherein in a treatment station,
the product carrier is heated,
a foodstuff mass is cast,
at least one shell is formed,
at least one opening is formed in at least one shell,
at least one shell is filled,
at least one cap is formed,
at least one semi-finished product is decorated and/or printed,
at least one mold is de-molded,
at least one mold is sprayed, and/or
at least one product is packaged.

33. The method according to claim 29, wherein the industrial robot detects a position of the at least one treatment station and determines an optimized method sequence.

34. A method for converting a system for producing foodstuffs having at least one treatment station, said method comprising the following steps:
dismantling an existing transportation device for conveying product carriers,
installing at least one industrial robot which comprises at least one effector having at least one receptacle for at least one product carrier and at least one manipulator for transferring the at least one product carrier, wherein the industrial robot additionally comprises at least one control installation, and the control installation is able to be set in such a manner that the product carrier is able to be:
shaken,
spun,
turned,
rotated,
displaced,
lifted,
lowered,
blown down,
suctioned,
cleaned,
stacked and/or unstacked,
cleared out by impact,
emptied,
filled,
temperature-controlled, and/or
moved along a predeterminable path.

35. The method according to claim 34, wherein the industrial robot additionally comprises at least one processing installation being associated with the at least one control installation.
